(19) United States
(12) Patent Application Publication
(10) Pub. No.: US 2017/0129704 A1
(43) Pub. Date: May 11, 2017

(54) STORAGE FACILITY USING AUTOMATED CARRYING CART

(71) Applicant: NAKANISHI METAL WORKS CO., LTD., Osaka-shi (JP)

(72) Inventors: Yoshihiro OKAZAKI, Osaka-shi (JP); Shu MATSUMOTO, Osaka-shi (JP)

(73) Assignee: NAKANISHI METAL WORKS CO., LTD., Osaka-shi (JP)

(21) Appl. No.: 15/223,651

(22) Filed: Jul. 29, 2016

(30) Foreign Application Priority Data
Aug. 11, 2015 (JP) 2015-159070

(51) Int. Cl. B65G 1/06; B65G 1/04

(52) U.S. Cl. CPC B65G 1/06; B65G 1/0492

(57) ABSTRACT

The present invention is intended to provide a storage facility using an automated carrying cart that is simplified in structure, and eliminates the need for a carrying means such as a conveyor or an unmanned carrying cart or a forklift operated by the worker.

A storage facility 1 uses an automated carrying cart A that carries an article W in and out of a shelf facility 2 having an article storage space S. The automated carrying cart A automatically runs in the shelf facility 2 along running rails G in paths Q1 and Q2, automatically runs on the ground outside the shelf facility 2 along specific paths P1 and P2, and is used in common for carrying the article W in the shelf facility 2 and carrying the article W on the ground outside the shelf facility 2.

### TECHNICAL FIELD

The present invention relates to a storage facility using an automated carrying cart that carries an article in and out of a shelf facility.

### BACKGROUND ART

There are storage facilities using an automated carrying cart that is composed of a stacker crane or a carry-in elevator and a carry-out elevator, and the automated carrying cart carrying articles in and out of a shelf facility having a multistory article storage space with a plurality of vertical stories (for example, refer to Patent Documents 1 and 2).

The storage facility using an automated carrying cart described in Patent Document 1 includes: a storage shelf (1) having upper, lower, right, and left storage parts (1a); a carrying cart (3) that runs in a running path (1b) to carry in and out an article (2) on a palette (2a); a stacker crane (5) that guides the carrying cart (3) to the running path (1b) in a predetermined storage part (1a); a carry-in roller conveyor (7a) and a carry-in chain conveyor (8a); a carry-out roller conveyor (7b) and a carry-out chain conveyor (8b); and a carry-in/out roller conveyor (7c), and others.

The carrying cart (3) includes a running electric motor (3b) that drives running wheels (3a), an elevating electric motor (30 that raises and lowers a loading stage (3e) on which the article (2) and the palette (2a) are placed, and others, and runs automatically in the running path (1b) of the storage parts (1a) in forward and backward directions.

The storage facility using an automated carrying cart described in Patent Document 2 is composed of running rails (8) that are extensively laid in a horizontal direction relative to vertical columns (12) erected extensively at equal intervals, and includes: a storage shelf (rack) with upper, lower, right, and left openings except for a carrying lane used as storage spaces for storing a load (16); a carry-in elevator (7) as a vertical conveyor, a stacker crane, or the like that is additionally provided on the carry-in side of the carrying lane; a carry-out elevator (9) as a vertical conveyor, a stacker crane, or the like that is additionally provided on the carry-out side of the carrying lane; an extensively-running carrying cart (30) that runs on the running rails (8) to transfer the load (16) between the elevators (7 and 9); a carry-in line (6) as a conveyor or the like connected to the carry-in elevator (7); a carry-out line (10) as a conveyor or the like connected to the carry-out elevator (9); and others.

The extensively-running carrying cart (30) includes: motors (33a, 33b, 33c, and 33d) that drive turnable wheels (32a, 32b, 32c, and 32d); turning cylinders 35a, 35b, 35c, and 35d that extend and contract to turn the wheels; an elevating motor (40) that raises and lowers an elevating table (41) on which the load (16) is placed; and others, and runs automatically in the storage space within the storage shelf along the running rails (8) in two directions, that is, a vertical direction (front-back direction) and a lateral direction (left-right direction).

### CITATION LIST

### Patent Literatures

Patent Document 1: JP-A No. H10-087020

Patent Document 2: JP-A No. H08-157016

### SUMMARY OF INVENTION

### Technical Problem

In the storage facility using an automated carrying cart described in Patent Document 1, the carrying cart (3) runs only in the storage shelf (1) and the stacker crane (5) to carry the article (2).

Accordingly, at the time of putting into storage, it is necessary to reload the article (2) from the carry-in roller conveyor (7a) to the carry-in chain conveyor (8a) and from the carry-in chain conveyor (8a) to the stacker crane (5). At the time of taking out of storage, it is necessary to reload the article (2) from the stacker crane (5) to the carry-out chain conveyor (8b) and from the carry-out chain conveyor (8b) to the carry-out roller conveyor (7b). This increases complexity in the structure of the storage facility.

In addition, the article (2) to be carried in and out is conveyed by the carry-in/out conveyor (7c). To carry the article (2) from a distant stock field to the storage shelf (1) and carry the article (2) from the storage shelf (1) to a distant shipment field, a carrying means such as a long carry-in/out conveyor (7c) or an unmanned carrying cart, or a forklift operated by the worker is required.

In the storage facility using an automated carrying cart described in Patent Document 2, the extensively-running carrying cart (30) runs only in the storage shelf, the carry-in elevator (7), and the carry-out elevator (9) to carry the load (16).

Accordingly, the conveyor and the like in the carry-in line (6) and the conveyor and the like in the carry-out line (10) are of forms not compatible with the extensively-running carrying cart (30). This requires a complicated transfer device that moves the load (16) between the carrying cart (30) in the elevators (7 and 9) and the conveyors in the carry-in and out lines (6 and 10), thereby resulting in the complicated structure of the storage facility.

Further, the load (16) to be carried in is conveyed by the conveyor or the like in the carry-in line (6), and the load (16) to be carried out is conveyed by the conveyor or the like in the carry-out line (10). To carry the load (16) from a distant stock field to the storage shelf and carry the load (16) from the storage shelf to a distant shipment field, a long conveyor constituting the carry-in line (6) and the carry-out line (10) or the like, or a carrying means such as an unmanned carrying cart, or a forklift operated by the worker is required.

In light of the foregoing circumstances, an object of the present invention is to provide a storage facility using an automated carrying cart that is simplified in structure, and eliminates the need for a carrying means such as a conveyor or an unmanned carrying cart, or a forklift operated by the worker to carry an article from a distant stock field to a shelf facility and carry the article from the shelf facility to a distant shipment field.

### Solution to Problem

To solve the foregoing problems, the storage facility using an automated carrying cart according to the present invention is a storage facility using an automated carrying cart that carries an article in and out of a shelf facility having an article storage space, wherein the automated carrying cart automatically runs in the shelf facility along running rails and automatically runs on the ground outside the shelf facility along a specific path, and the automated carrying cart is used in common for carrying the article in the shelf facility and carrying the article on the ground outside the shelf facility (claim 1).

According to the foregoing configuration, the automated carrying cart automatically running in the shelf facility along the running rails and automatically running on the ground outside the shelf facility along the specific path is used in common for carrying the article in the shelf facility and carrying the article on the ground outside the shelf facility, which eliminates the need for a transfer device for unloading and reloading the article at the entry and exit of the shelf facility, thereby achieving the simplified structure of the storage facility.

In addition, the automated carrying cart can automatically run on the ground outside the shelf facility along a specific path, which eliminates a carrying means such as a conveyor or an unmanned carrying cart, or a forklift operated by the worker to carry an article from a distant stock field to the shelf facility and carry the article from the shelf facility to a distant shipment field.

It is preferred that the running rails are provided in the front-back direction and the left-right direction of the automated carrying cart, and the automated carrying cart automatically runs in the shelf facility along the running rails in the front-back direction and the left-right direction (claim 2).

According to this configuration, the automated carrying cart automatically runs in the shelf facility along the running rails in the front-back direction and the left-right direction, which eliminates the need for a stacker crane and a space for moving the stacker crane.

It is further preferred that the automated carrying cart includes first running wheels and second running wheels with an axis of rotation orthogonal to that of the first running wheels, and the automated carrying cart includes a switch means that switches between the state in which the first running wheels are grounded and the second running wheels are lifted and the state in which the second running wheels are grounded and the first running wheels are lifted (claim 3).

According to this configuration, the switch means can switch between the state in which the first running wheels are grounded and the second running wheels are lifted and the state in which the second running wheels are grounded and the first running wheels are lifted. Accordingly, it is possible to allow the automated carrying cart to run in the orthogonal direction by switching between running in the front-back direction and running in the left-right direction with a simplified structure.

It is further preferred that driving torque of a running drive device is transferred to both the first running wheels and the second running wheels (claim 4).

According to this configuration, the number of the running drive devices can be reduced to achieve space saving and cut manufacturing costs.

It is further preferred that separate running drive devices drive the right and left first running wheels or the right and left second running wheels for use in running on the ground outside the shelf facility (claim 5).

According to this configuration, it is easy to allow the automated carrying cart to run in a curved path by changing the velocities of the right and left driving wheels driven by the separate running drive devices. This increases the degree of freedom to run the automated carrying cart along a specific path on the ground outside the shelf facility.

It is further preferred that the shelf facility has an article storage space with a plurality of vertical stories, and includes an elevating device for passing the automated carrying cart between a position on the story at a desired height and a position on the ground (claim 6).

According to this configuration, including merely the elevating device makes it possible to be compatible with a shelf facility having a multistory article storage space. This enhances the efficiency of the storage space in the shelf facility taking advantage of the simplified structure of the storage facility.

It is further preferred that the automated carrying cart automatically runs and enters into the elevating device, and automatically runs and exits from the elevating device (claim 7).

According to this configuration, the automated carrying cart automatically runs and enters into or exits from the elevating device, which eliminates the need to provide a transfer device for unloading and reloading the article on the upstream and downstream sides of the elevating device.

### Advantageous Effects of Invention

According to the storage facility using the automated carrying cart according to the present invention, the automated carrying cart is used in common for carrying in the shelf facility and carrying on the ground. This provides advantages of achieving the simplified structure of the storage facility and eliminating the need for a carrying means such as a conveyor or an unmanned carrying cart, or a forklift operated by the worker to carry an article from a distant stock field to the shelf facility and carry the article from the shelf facility to a distant shipment field.

### BRIEF DESCRIPTION OF DRAWINGS

FIG. 1(a) and FIG. 1(b) include schematic diagrams illustrating an example of a case in which a storage facility using an automated carrying cart has a first-in last-out multistory article storage space, and FIG. 1(a) is a plane view and FIG. 1(b) is a front view;

FIG. 2(a) and FIG. 2(b) include enlarged schematic plane views of main components illustrating an example of a case in which the automated carrying cart runs in an orthogonal direction in a shelf facility, and FIG. 2(a) shows the state in which the automated carrying cart having run in a carrying direction T1 stops at an intersection for moving in the orthogonal direction, and FIG. 2(b) shows the state in which the automated carrying cart runs in a carrying direction T2 orthogonal to the carrying direction T1;

FIG. 3(a) and FIG. 3(b) include enlarged schematic front views of main components illustrating an operation of the automated carrying cart carrying an article into a predetermined carry-in place within the shelf facility, and FIG. 3(a) shows the state in which an elevating table is raised to reach the predetermined carry-in place, and FIG. 3(b) shows the state in which the elevating table is lowered and loaded with the article on placement parts;

FIG. 4 is a perspective view of the automated carrying cart;

FIG. 5 is an exploded perspective view of a main frame and sub frames;

FIG. 6 is an exploded perspective view of the main frame and the elevating table;

FIG. 7 is a schematic plane view of main components of a driving system of the automated carrying cart from which the elevating table and a cover are removed;

FIG. 8 is a right side view illustrating the state in which second running wheels are lifted and first running wheels are grounded by a switch means;

FIG. 9 is a right side view illustrating the state in which the first running wheels are lifted and the second running wheels are grounded by the switch means;

FIG. 10 is a front view illustrating the state in which the elevating table is lowered;

FIG. 11 is a front view illustrating the state in which the elevating table is raised;

FIG. 12(a) and FIG. 12(b) include schematic views illustrating an example of a case in which a storage facility using an automated carrying cart has a first-in first-out multistory article storage space, and FIG. 12(a) is a plane view and FIG. 12(b) is a front view;

FIG. 13(a) and FIG. 13(b) include schematic views illustrating an example of a case in which a storage facility using an automated carrying cart has a random carry-in/out multistory article storage space, and FIG. 13(a) is a plane view and FIG. 13(b) is a front view;

FIG. 14 is a schematic plane view illustrating an example of a case in which a storage facility using an automated carrying cart has a first-in last-out plane article storage space;

FIG. 15 is a schematic plane view illustrating an example of a case in which a storage facility using an automated carrying cart has a first-in first-out plane article storage space;

FIG. 16 is a schematic plane view illustrating an example of a case in which a storage facility using an automated carrying cart has a random carry-in/out plane article storage space; and

FIG. 17 is a schematic right side view of an automated carrying cart including a telescopic fork.

### DESCRIPTION OF EMBODIMENTS

Embodiments of the present invention will be described below with reference to the drawings.

For a shelf facility described herein, the front, back, left, and right sides are defined in the direction from the entry to the back of an article storage space, and the view as seen from the back to front sides is defined as a front view.

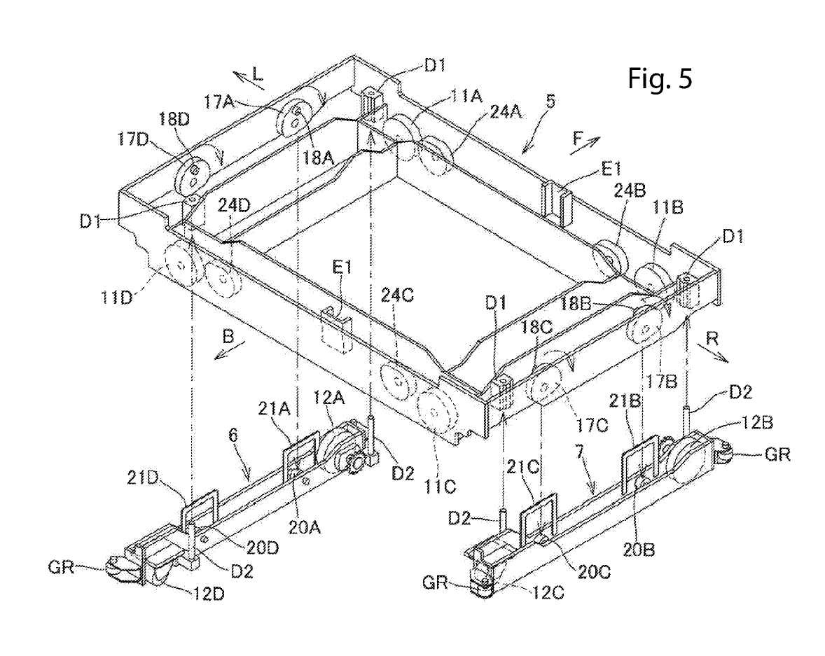

For an automated carrying cart, the front, back, left, and right sides are defined by arrows F, B, L, and R in FIGS. 5 to 7, and the view as seen from the back to front sides is defined as a front view.

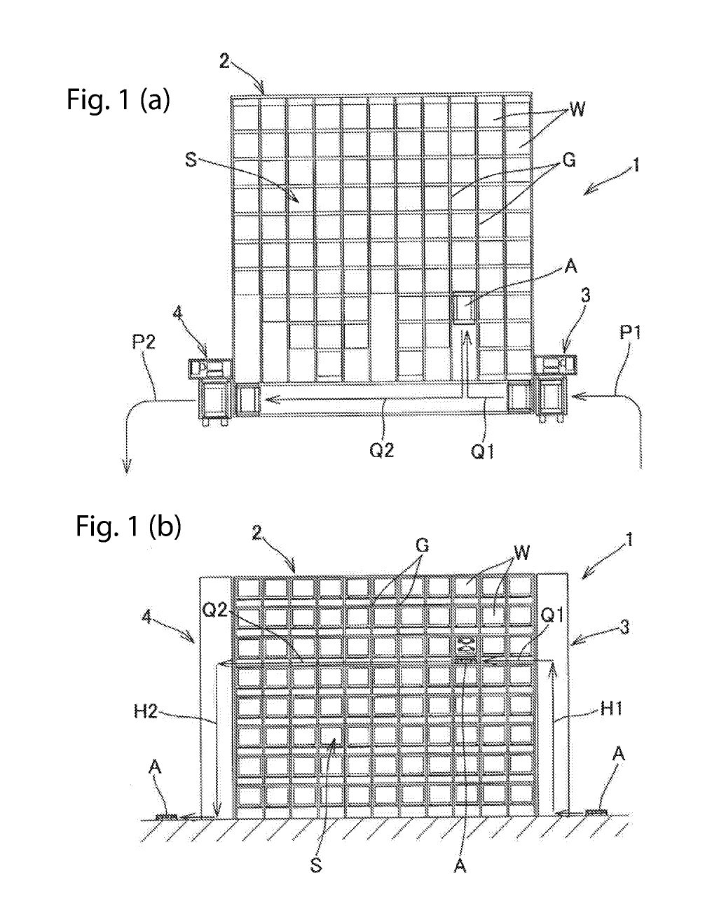

The storage facility using the automated carrying cart according to the embodiment of the present invention illustrated in the schematic plane view of FIG. 1(a) and the schematic front view of FIG. 1(b) has a first-in last-out multistory article storage space as an example.

A storage facility 1 allows the automated carrying cart A to carry an article W in or out of a shelf facility 2 having the high-space efficient multistory article storage space S with a plurality of vertical stories.

The storage facility 1 includes elevating devices 3 and 4 to pass the automated carrying cart A between a position on the story at a desired height in the article storage space S and a position on the ground, and uses the automated carrying cart A in common for carrying the article W in the shelf facility 2 and carrying the article W on the ground outside the shelf facility 2.

The automated carrying cart A automatically runs in the shelf facility 2 in the front-back direction and the left-right direction along running rails G provided on the individual stories in the front-back direction and the left-right direction of the automated carrying cart A. The automated carrying cart A automatically runs on the ground outside the shelf facility 2 along specific paths P1 and P2 determined by guide lines or guide marks of magnetic tapes or the like laid on the floor.

According to this configuration, the automated carrying cart A automatically runs in the shelf facility 2 along the running rails G in the front-back direction and the left-right direction to eliminate the need for a stacker crane and a space for moving the stacker crane.

In addition, including merely the elevating devices 3 and 4 in addition to the shelf facility 2 and a desired number of automated carrying carts A makes it possible to be compatible with the shelf facility 2 having the multistory article storage space S.

Further, the automated carrying cart A automatically runs and enters into or exits from the elevating devices 3 and 4, thereby to eliminate the need to provide a transfer device for unloading and reloading the article on the upstream and downstream sides of the elevating devices 3 and 4.

Next, the operation of the storage facility 1 using the automated carrying cart A will be described.

### <Example of a Case of Carrying the Article W in the Shelf Facility 2>

(1) The automated carrying cart A loaded with the article W at a stock field not illustrated automatically runs along a specific path P1 on the ground and enters into the elevating device 3.

(2) The elevating device 3 raises the automated carrying cart A up to the height of the desired story as in a raising path H1.

(3) The automated carrying cart A automatically runs and exits from the elevating device 3, and then automatically runs along a path Q1 in the shelf facility 2 while the elevating table and the article W are raised by an elevating drive device included in the automated carrying cart A.

(4) When having reached a predetermined carry-in place, the automated carrying cart A lowers the elevating table by the elevating drive device to place the article W on the predetermined carry-in place.

(5) The unloaded automated carrying cart A automatically runs along a path Q2 in the shelf facility 2 and enters into the elevating device 4.

(6) The elevating device 4 lowers the automated carrying cart A from the height of the desired story to the ground as in a lowering path H2.

(7) The automated carrying cart A automatically runs and exits from the elevating device 4, and then automatically runs along a specific path P2 on the ground.

The details of operation of the automated carrying cart A running in the orthogonal direction and carrying the article W in a predetermined carry-in place as in the path Q1 of FIG. 1(a) and FIG. 1(b) will be described.

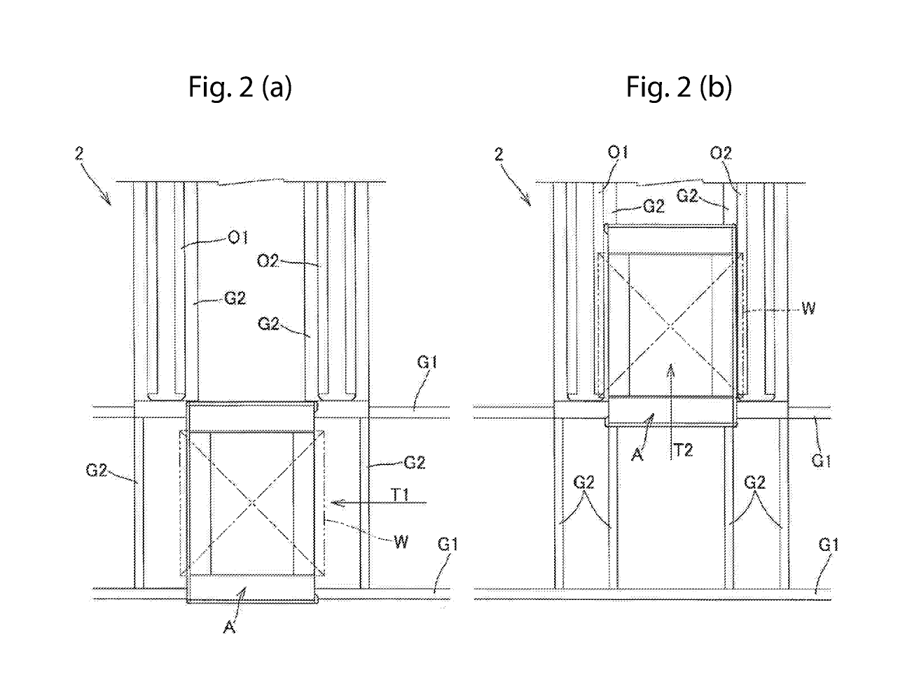

As illustrated in the enlarged schematic plane view of main components of FIG. 2(a), the automated carrying cart A having run on running rails G1 and G1 along a carrying direction T1 stops at an intersection for running in the orthogonal direction.

Next, as illustrated in the enlarged schematic plane view of main components of FIG. 2(a), the automated carrying cart A moves on running rails G2 and G2 along a carrying direction T2 orthogonal to the carrying direction T1.

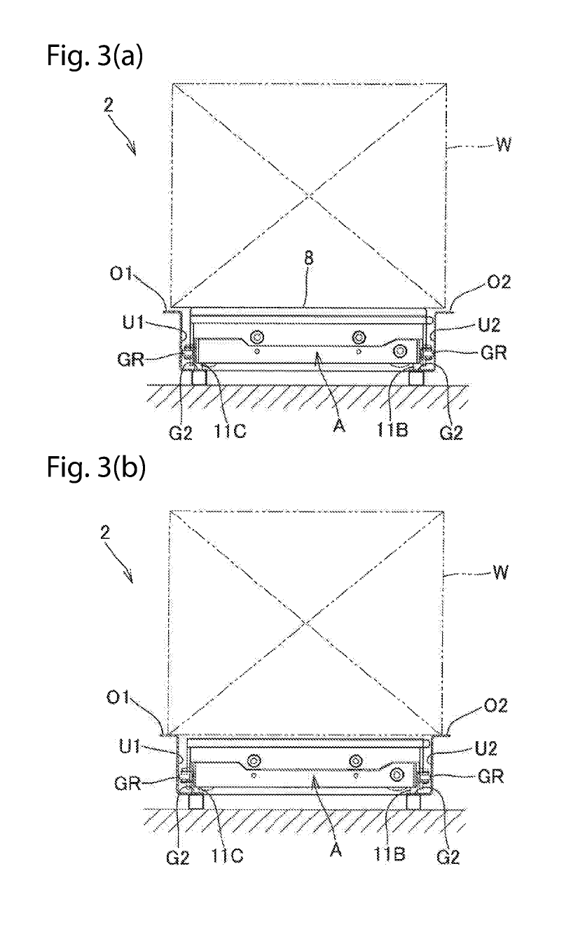

At that time, as illustrated in the enlarged schematic front view of main components of FIG. 3(a) and FIG. 3(b), left and right guide rollers GR, GR, . . . of the automated carrying cart A are guided by left and right guide surfaces U1 and U2 to regulate rightward and leftward shifts of the automated carrying cart A.

Then, the automated carrying cart A having reached the predetermined carry-in place lowers by the elevating drive device an elevating table 8 raised as illustrated in the enlarged schematic front view of main components of FIG. 3(a) to place the article W on placement parts O1 and O2 as illustrated in the enlarged schematic front view of main components of FIG. 3(b).

### <Example of a Case of Carrying the Article W Out of the Shelf Facility 2>

(1) The unloaded automated carrying cart A automatically runs along the specific path P1 on the ground and enters into the elevating device 3.

(2) The elevating device 3 raises the automated carrying cart A up to the height of the desired story as in the raising path H1.

(3) The automated carrying cart A automatically runs and exits from the elevating device 3, and then automatically runs along the path Q1 in the shelf facility 2 while the elevating table is lowered by the elevating drive device.

(4) The automated carrying cart A having reached a predetermined carry-out place raises the elevating table by the elevating drive device to place the article W from the predetermined carry-out place onto the elevating table.

(5) The automated carrying cart A loaded with the article W automatically runs along the path Q2 in the shelf facility 2 and enters into the elevating device 4.

(6) The elevating device 4 lowers the automated carrying cart A from the height of the desired story to the ground as in the lowering path H2.

(7) The automated carrying cart A automatically runs and exits from the elevating device 4, and then automatically runs to a shipment field not illustrated along the specific path P2 on the ground.

Next, a configuration example of the automated carrying cart A will be described.

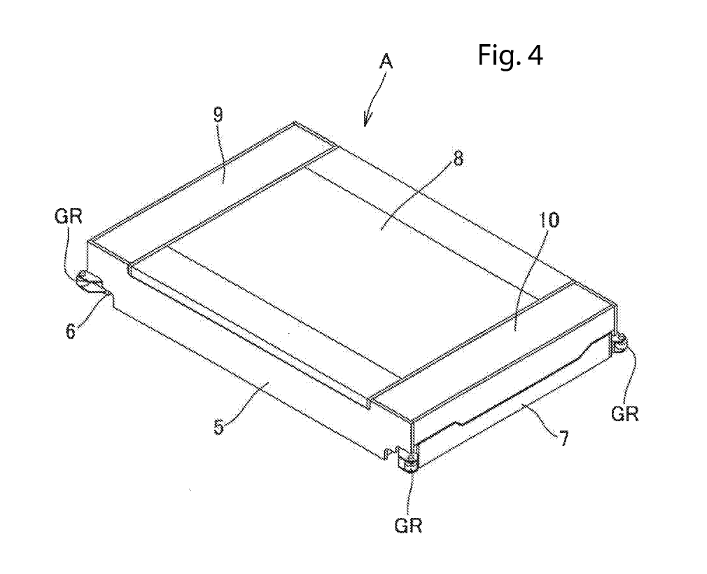

As illustrated in the perspective view of FIG. 4, the automated carrying cart A includes a main frame 5, sub frames 6 and 7, the elevating table 8, and covers 9 and 10.

As illustrated in the exploded perspective view of FIG. 5, pins D2, D2, . . . of the sub frames 6 and 7 are inserted into linear bushes D1, D1, . . . of the main frame 5. Accordingly, the sub frames 6 and 7 are supported by the main frame 5 in such a manner as to be raised and lowered.

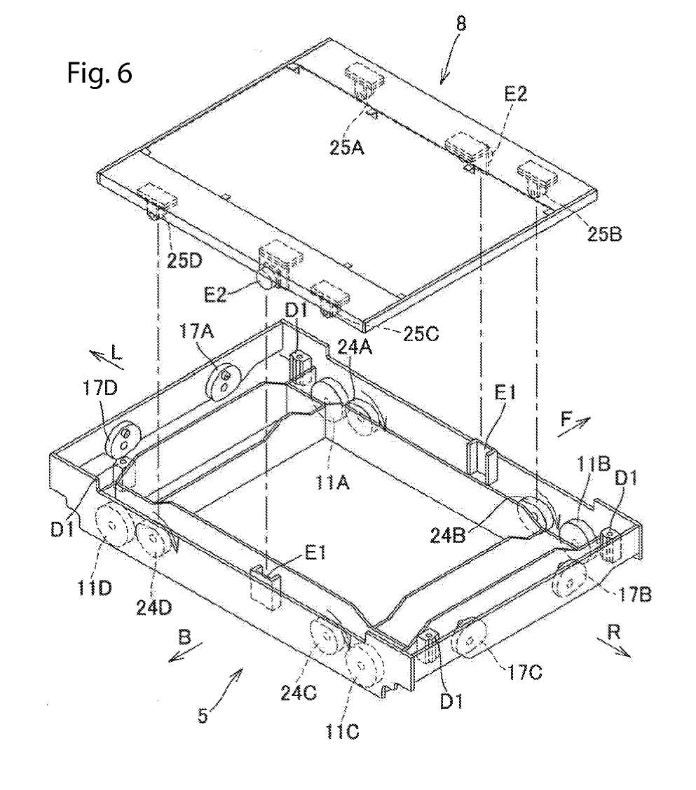

As illustrated in the exploded perspective view of FIG. 6, guide rollers E2 and E2 of the elevating table 8 are engaged with guide blocks E1 and E1 of the main frame 5. Accordingly, the elevating table 8 is supported by the main frame 5 in such a manner as to be raised and lowered.

As illustrated in FIG. 5, the main frame 5 has first running wheels 11A, 11B, 11C, and 11D pivotally supported on the left front, right front, right back, and left back sides.

The left sub frame 6 has second running wheels 12A and 12D pivotally supported on the front and back sides. The right sub frame 7 has second running wheels 12B and 12C pivotally supported on the front and back sides. The second running wheels 12A to 12D have a rotation axis orthogonal to the rotation axis of the first running wheels 11A to 11D.

The second running wheels 12C and 12D are casters rotatable around a vertical axis and are not driven by the running drive devices.

The sub frames 6 and 7 also have horizontal guide rollers GR, GR, . . . pivotally supported. Accordingly, when the automated carrying cart A runs in the shelf facility 2, the guide rollers GR, GR, . . . are guided by left and right guide surfaces (for example, see the guide surfaces U1 and U2 illustrated in FIG. 3(a) and FIG. 3(b)).

The main frame 5 has switch cams 17A, 17B, 17C, and 17D pivotally supported on the left front, right front, right back, and left back sides. The main frame 5 has rollers 18A, 18B, 18C, and 18D erected in the left-right direction on inner surface sides of the switch cams 17A, 17B, 17C, and 17D.

The left sub frame 6 has cam followers 20A and 20D pivotally supported on the front and back sides to abut with the switch cams 17A and 17D of the main frame 5 from beneath. The left sub frame 6 also has left-right directional vision portal hangers 21A and 21D provided in such a manner as to be pushed up by the rollers 18A and 18D to raise the sub frame 6 relative to the main frame 5.

The right sub frame 7 has cam followers 20B and 20C pivotally supported on the front and back sides to abut with the switch cams 17B and 17C of the main frame 5 from beneath. The right sub frame 7 also has left-right directional vision portal hangers 21B and 21C provided in such a manner as to be pushed up by the rollers 18B and 18C to raise the sub frame 7 relative to the main frame 5.

As illustrated in FIG. 6, the main frame 5 has elevating cams 24A, 24B, 24C, and 24D pivotally supported on the left front, right front, right back, and left back sides.

The elevating table 8 has cam followers 25A, 25B, 25C, and 25D provided on the left front, right front, right back, and left back sides of the lower surface in such a manner as to abut with the elevating cams 24A, 24B, 24C, and 24D of the main frame 5 from above.

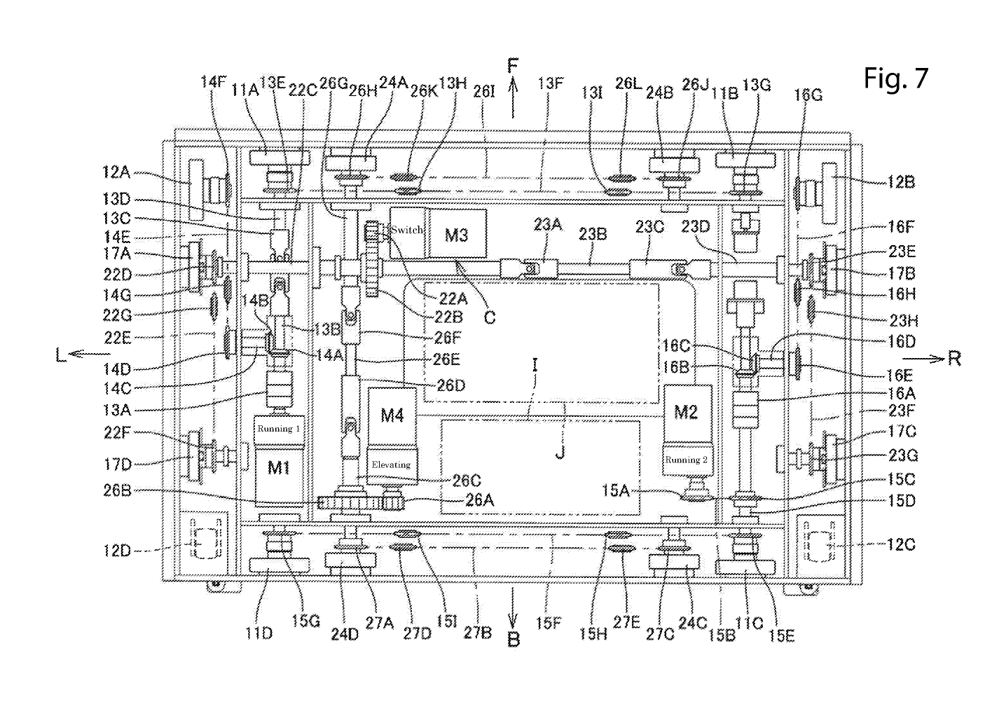

Main components of the drive system will be described with reference to the schematic plane view of FIG. 7 illustrating the state without the elevating table 8 and the covers 9 and 10.

A buttery I supplies power, and a drive control system J drives and controls a first running drive device M1, a second running drive device M2, a switch drive device M3, and an elevating drive device M4.

These drive devices M1, M2, M3, and M4 are motors equipped with speed reducers.

### <Drive System in the First Running Drive Device M1>

The output shaft of the first running drive device M1 illustrated in FIG. 7 is connected to a coupling 13A to transfer drive torque of the first running drive device M1 to a shaft 13B, a universal joint 13C, and a shaft 13D. Accordingly, the first running wheel 11A is driven by the first running drive device M1.

In addition, the drive torque of the first running drive device M1 is transferred by a sprocket 13E, a chain 13F, and a sprocket 13G. Accordingly, the first running wheel 11B is driven by the first running drive device M1.

The tension of the chain 13F can be adjusted by idler sprockets 13H and 13I.

Further, the drive torque of the first running drive device M1 is transferred by bevel gears 14A and 14B, a shaft 14C, a sprocket 14D, a chain 14E, and a sprocket 14F. Accordingly, the second running wheel 12A is driven by the first running drive device M1.

The tension of the chain 14E can be adjusted by an idler sprocket 14G.

### <Drive System in the Second Running Drive Device M2>

The output shaft of the second running drive device M2 illustrated in FIG. 7 is connected to a sprocket 15A to transfer drive torque of the second running drive device M2 to a chain 15B, a sprocket 15C, and a shaft 15D. Accordingly, the first running wheel 11C is driven by the second running drive device M2.

In addition, the drive torque of the second running drive device M2 is transferred by a sprocket 15E, a chain 15F, and a sprocket 15G. Accordingly, the first running wheel 11D is driven by the second running drive device M2.

The tension of the chain 15F can be adjusted by idler sprockets 15H and 151.

Further, the shaft 15D is connected to a coupling 16A, bevel gears 16B and 16C, a shaft 16D, a sprocket 16E, a chain 16F, and a sprocket 16G. Accordingly, the second running wheel 12B is driven by the second running drive device M2.

The tension of the chain 16F can be adjusted by an idler sprocket 16H.

As described above, the drive torque of the first running drive device M1 is transferred to the first running wheels 11A and 11B and the second running wheel 12A, and the drive torque of the second running drive device M2 is transferred to the first running wheels 11C and 11D and the second running wheel 12B.

In this manner, the two running drive devices M1 and M2 drive the four first running wheels 11A to 11D and the two second running wheels 12A and 12B. This decreases the number of the running drive devices to achieve space saving and reduction in manufacturing costs.

### <Drive System in the Switch Drive Device M3>

The output shaft of the switch drive device M3 illustrated in FIG. 7 is connected to a spur gear 22A to transfer drive torque of the switch drive device M3 to a spur gear 22B and a shaft 22C. Accordingly, the switch cam 17A is driven by the switch drive device M3.

In addition, the drive torque of the switch drive device M3 is transferred by a sprocket 22D, a chain 22E, and a sprocket 22F. Accordingly, the switch cam 17D is driven by the switch drive device M3.

The tension of the chain 22E can be adjusted by an idler sprocket 22G.

Further, the drive torque of the switch drive device M3 is transferred by the shaft 22C, a universal joint 23A, a shaft 23B, a universal joint 23C, and a shaft 23D. Accordingly, the switch cam 17B is driven by the switch drive device M3.

Furthermore, the drive torque of the switch drive device M3 is transferred by a sprocket 23E, a chain 23F, and a sprocket 23G. Accordingly, the switch cam 17C is driven by the switch drive device M3.

The tension of the chain 23F can be adjusted by an idler sprocket 23H.

As described above, the switch cams 17A to 17D can be rotated by driving the switch drive device M3.

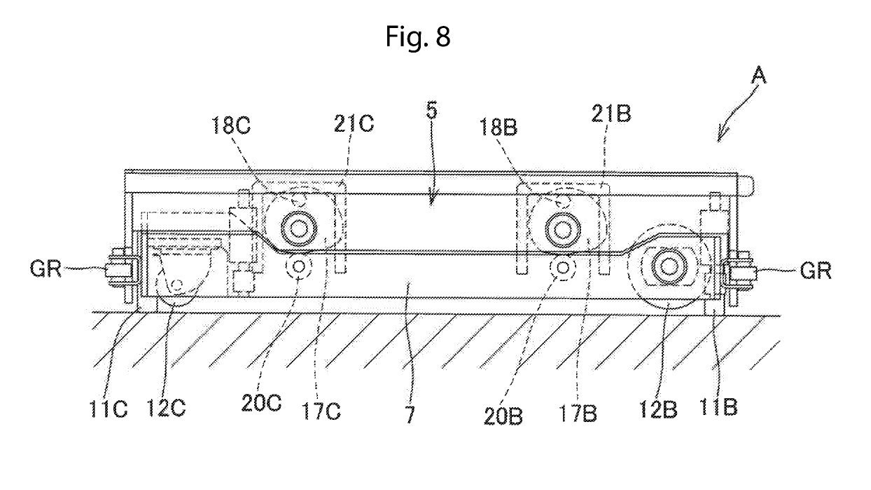

At the rotational positions of the switch cams 17B and 17C illustrated in the right side view of FIG. 8 (also at the rotational positions of the switch cams 17A and 17D), the hangers 21A to 21D are pushed up by the rollers 18A to 18D. Accordingly, the second running wheels 12A to 12D are lifted and the first running wheels 11A to 11D are grounded.

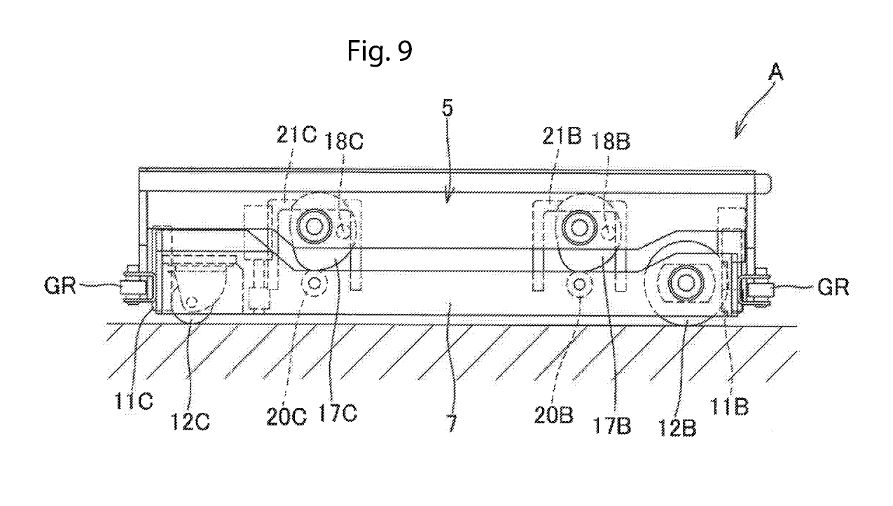

Meanwhile, at the rotational positions of the switch cams 17B and 17C illustrated in the right side view of FIG. 9 (also at the rotational positions of the switch cams 17A and 17D), the cam followers 20A to 20D are pushed down by the switch cams 17A to 17D. Accordingly, the first running wheels 11A to 11D are lifted and the second running wheels 12A to 12D are grounded.

The switch drive device M3 and its drive system, the switch cams 17A to 17D, the rollers 18A to 18D, the hangers 21A to 21D, and the cam followers 20A to 20D raise and lower the sub frames 6 and 7 relative to the main frame 5, thereby to constitute a switch means C that switches between the state in which the first running wheels 11A to 11D are grounded and the second running wheels 12A to 12D are lifted and the state in which the second running wheels 12A to 12D are grounded and the first running wheels 11A to 11D are lifted.

By the switch means C simple in structure and reliable in operation, it is easy to switch between the state in which the first running wheels 11A to 11D are grounded and the state in which the second running wheels 12A to 12D are grounded.

In the state in which the four first running wheels 11A to 11D are grounded and the four second running wheels 12A to 12D are lifted by the switch means C, all the four first running wheels 11A to 11D are driven to allow stable straight-ahead running to a left side L or a right side R illustrated in FIG. 7.

In the state in which the four second running wheels 12A to 12D are grounded and the four first running wheels 11A to 11D are lifted by the switch means C, the second running wheels 12A and 12B are driven and the second running wheels 12C and 12D as casters are not driven. In this state, straight-ahead running to a front side F or a back side B illustrated in FIG. 7 is enabled. In addition, running in a curved path is also enabled by changing the velocities of the second running wheels 12A and 12B by the separate running drive devices M1 and M2 to make a difference.

In this manner, it is easy to allow the automated carrying cart A to run in a curved path by varying the velocities of the right and left running wheels driven by the separate running drive devices M1 and M2, thereby to increase the degree of freedom of path setting for the automated carrying cart A to run along a specific path on the ground.

### <Drive System in the Elevating Drive Device M4>

The output shaft of the elevating drive device M4 illustrated in FIG. 7 is connected to a spur gear 26A to transfer drive torque of the elevating drive device M4 to a spur gear 26B, a shaft 26C, a universal joint 26D, a shaft 26E, a universal joint 26F, and a shaft 26G. Accordingly, the elevating cam 24A is driven by the elevating drive device M4.

In addition, the drive torque of the elevating drive device M4 is transferred by a sprocket 26H, a chain 26I, and a sprocket 26J. Accordingly, the elevating cam 24B is driven by the elevating drive device M4.

The tension of the chain 26I can be adjusted by idler sprockets 26K and 26L.

Further, the drive torque of the elevating drive device M4 is transferred to the shaft 26C. Accordingly, the elevating cam 24D is driven by the elevating drive device M4.

Furthermore, the drive torque of the elevating drive device M4 is transferred by a sprocket 27A, a chain 27B, and a sprocket 27C. Accordingly, the elevating cam 24C is driven by the elevating drive device M4.

The tension of the chain 27B can be adjusted by idler sprockets 27D and 27E.

As described above, the elevating cams 24A, 24B, 24C, and 24D can be rotated by driving the elevating drive device M4.

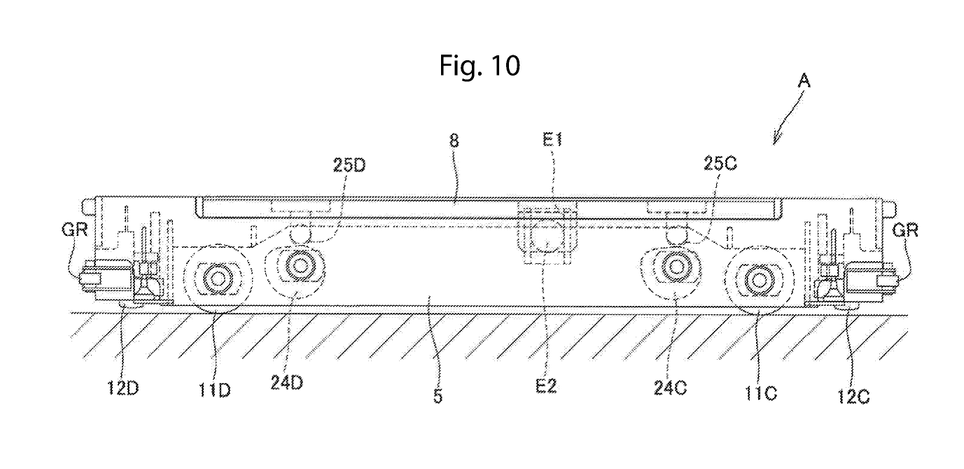

At the rotational positions of the elevating cams 24C and 24D illustrated in the front view of FIG. 10 (also at the rotational positions of the elevating cams 24A and 24B), the upper surfaces of the elevating cams 24A to 24D with which the cam followers 25A to 25D abut are low and the elevating table 8 is in the lowered state.

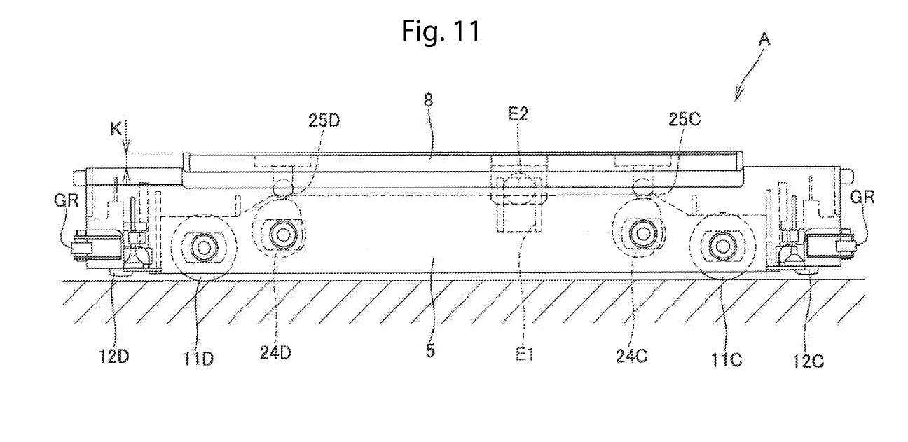

Meanwhile, at the rotational positions of the elevating cams 24C and 24D illustrated in the front view of FIG. 11 (also at the rotational positions of the elevating cams 24A and 24B), the upper surfaces of the elevating cams 24A to 24D with which the cam followers 25A to 25D abut are high and the elevating table 8 is in the raised state (elevating stroke K).

Next, a modification example of a storage facility using an automated carrying cart will be explained.

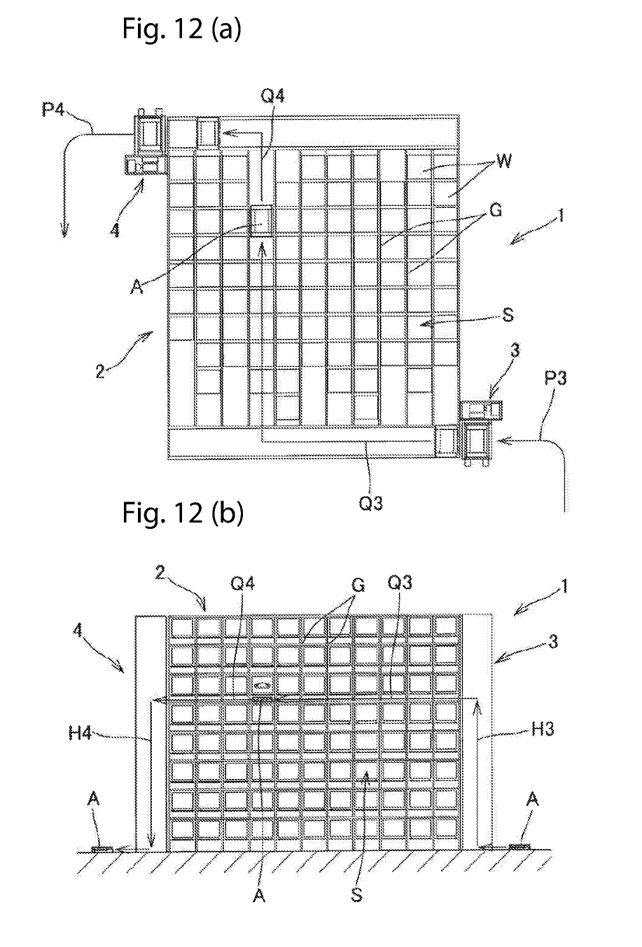

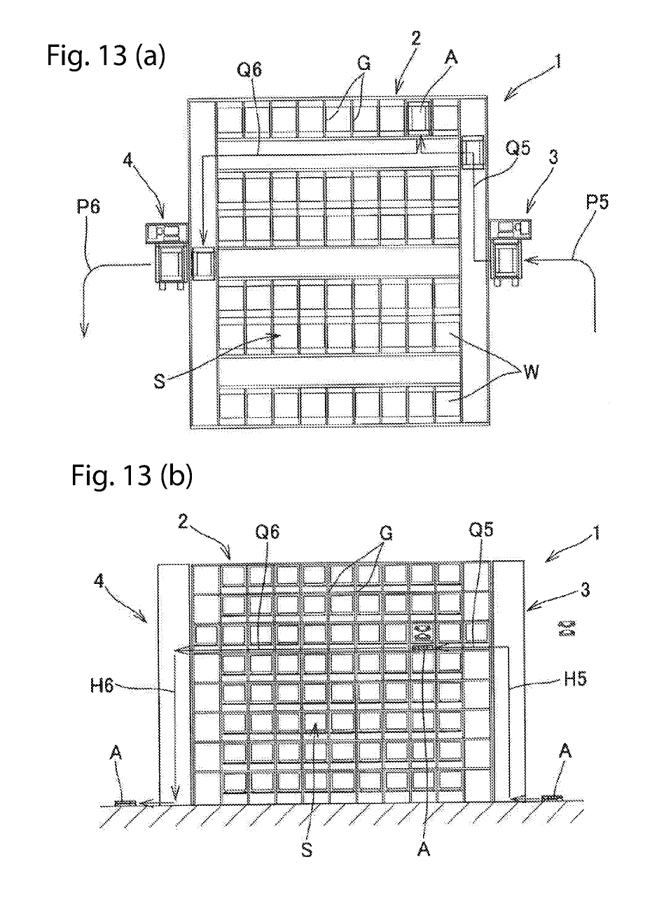

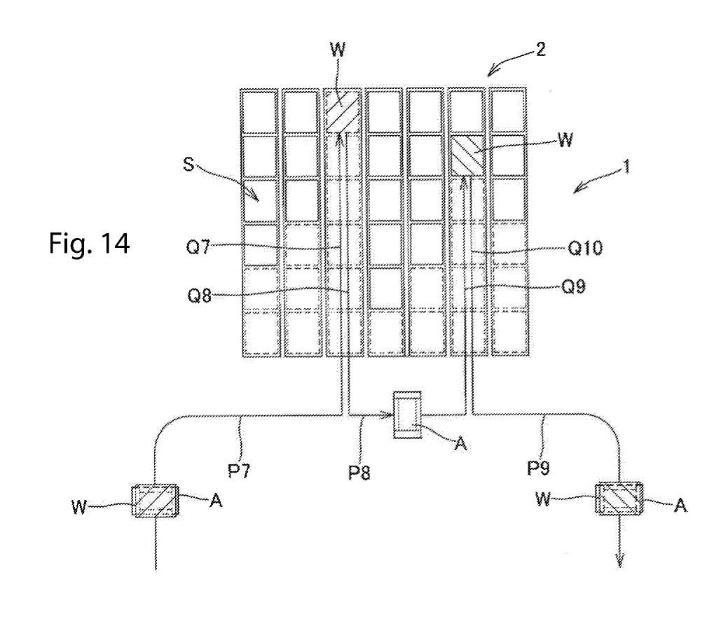

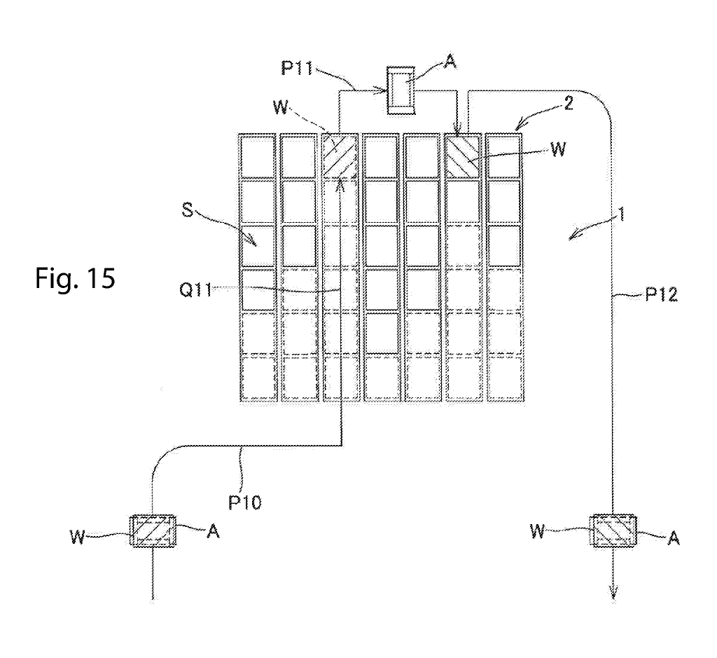

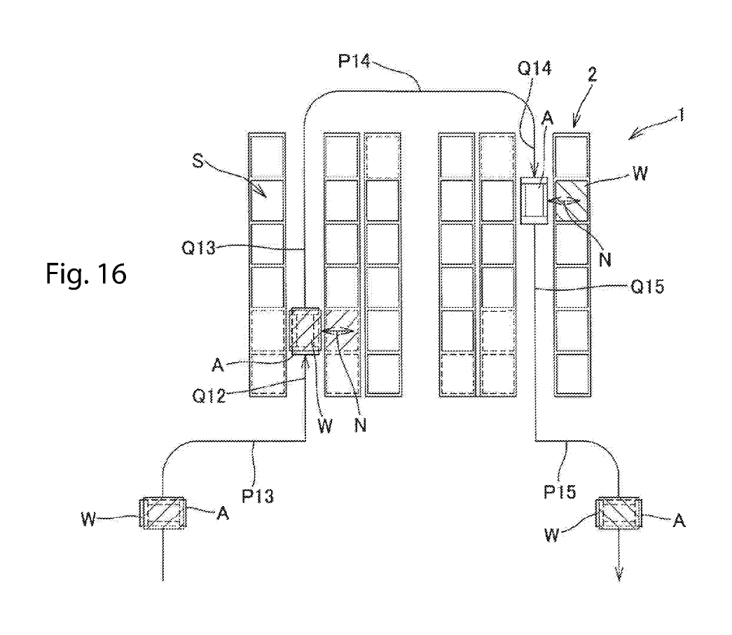

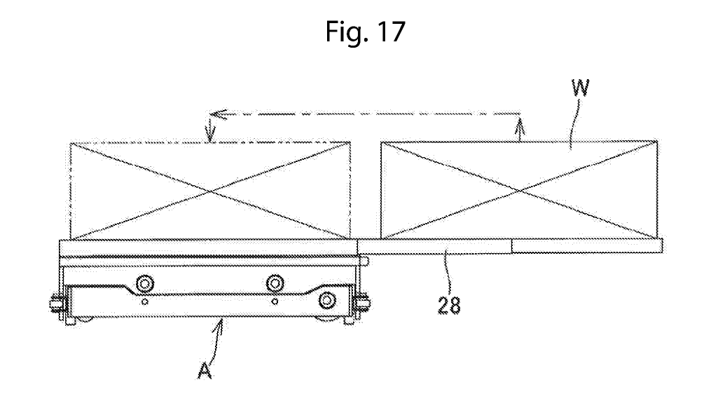

In FIG. 12(a), FIG. 12(b), FIG. 13(a), FIG. 13(b), FIG. 14, FIG. 15, FIG. 16 and FIG. 17, the same reference signs as those in FIG. 1(a) and FIG. 1(b) denote components identical or equivalent to those illustrated in FIG. 1(a) and FIG. 1(b).

The storage facility using an automated carrying cart according to the embodiment of the present invention illustrated in the schematic plane view of FIG. 12(a) and the schematic front view of FIG. 12(b) has a first-in first-out multistory article storage space as an example.

### <Example of a Case of Carrying the Article W in the Shelf Facility 2>

(1) The automated carrying cart A loaded with the article W at a stock field not illustrated automatically runs along a specific path P3 on the ground and enters into the elevating device 3.

(2) The elevating device 3 raises the automated carrying cart A up to the height of the desired story as in a raising path H3.

(3) The automated carrying cart A automatically runs and exits from the elevating device 3, and then automatically runs along a path Q3 in the shelf facility 2 while the elevating table and the article W are raised by the elevating drive device.

(4) When having reached a predetermined carry-in place, the automated carrying cart A lowers the elevating table by the elevating drive device to place the article W on the predetermined carry-in place.

(5) The unloaded automated carrying cart A automatically runs along a path Q4 in the shelf facility 2 and enters into the elevating device 4.

(6) The elevating device 4 lowers the automated carrying cart A from the height of the desired story to the ground as in a lowering path H4.

(7) The automated carrying cart A automatically runs and exits from the elevating device 4, and then automatically runs along a specific path P4 on the ground.

### <Example of a Case of Carrying the Article W Out of the Shelf Facility 2>

(1) The unloaded automated carrying cart A automatically runs along the specific path P3 on the ground and enters into the elevating device 3.

(2) The elevating device 3 raises the automated carrying cart A up to the height of the desired story as in the raising path H3.

(3) The automated carrying cart A automatically runs and exits from the elevating device 3, and then automatically runs along the path Q3 in the shelf facility 2 while the elevating table is lowered by the elevating drive device.

(4) The automated carrying cart A having reached a predetermined carry-out place raises the elevating table by the elevating drive device to place the article W from the predetermined carry-out place onto the elevating table.

(5) The automated carrying cart A loaded with the article W automatically runs along the path Q4 in the shelf facility 2 and enters into the elevating device 4.

(6) The elevating device 4 lowers the automated carrying cart A from the height of the desired story to the ground as in the lowering path H4.

(7) The automated carrying cart A automatically runs and exits from the elevating device 4, and then automatically runs to a shipment field not illustrated along the specific path P4 on the ground.

The storage facility using an automated carrying cart according to the embodiment of the present invention illustrated in the schematic plane view of FIG. 13(a) and the schematic front view of FIG. 13(b) has a random carry-in/out multistory article storage space as an example.

### <Example of a Case of Carrying the Article W in the Shelf Facility 2>

(1) The automated carrying cart A loaded with the article W at a stock field not illustrated automatically runs along a specific path P5 on the ground and enters into the elevating device 3.

(2) The elevating device 3 raises the automated carrying cart A up to the height of the desired story as in a raising path H5.

(3) The automated carrying cart A automatically runs and exits from the elevating device 3, and then automatically runs along a path Q5 in the shelf facility 2 while the elevating table and the article W are raised by the elevating drive device.

(4) The automated carrying cart A having reached a predetermined carry-in place lowers the elevating table by the elevating drive device to place the article W on the predetermined carry-in place.

(5) The unloaded automated carrying cart A automatically runs along a path Q6 in the shelf facility 2 and enters into the elevating device 4.

(6) The elevating device 4 lowers the automated carrying cart A from the height of the desired story to the ground as in a lowering path H6.

(7) The automated carrying cart A automatically runs and exits from the elevating device 4, and then automatically runs along a specific path P6 on the ground.

### <Example of a Case of Carrying the Article W Out of the Shelf Facility 2>

(1) The unloaded automated carrying cart A automatically runs along the specific path P5 on the ground and enters into the elevating device 3.

(2) The elevating device 3 raises the automated carrying cart A up to the height of the desired story as in the raising path H5.

(3) The automated carrying cart A automatically runs and exits from the elevating device 3, and then automatically runs along the path Q5 in the shelf facility 2 while the elevating table is lowered by the elevating drive device.

(4) The automated carrying cart A having reached a predetermined carry-out place raises the elevating table by the elevating drive device to place the article W from the predetermined carry-out place onto the elevating table.

(5) The automated carrying cart A loaded with the article W automatically runs along the path Q6 in the shelf facility 2 and enters into the elevating device 4.

(6) The elevating device 4 lowers the automated carrying cart A from the height of the desired story to the ground as in the lowering path H6.

(7) The automated carrying cart A automatically runs and exits from the elevating device 4, and then automatically runs to a shipment field not illustrated along the specific path P6 on the ground.

The storage facility using an automated carrying cart according to the embodiment of the present invention illustrated in the schematic plane view of FIG. 14 has a first-in last-out plane article storage space as an example.

The article storage space S is not a multistory space with a plurality of vertical stories but a plane space, and therefore the elevating devices 3 and 4 as illustrated in FIGS. 1, 12, and 13 are not required.

### <Example of a Case of Carrying the Article Win and Out of the Shelf Facility 2>

(1) The automated carrying cart A loaded with the article W automatically runs along a specific path P7 and enters into the shelf facility 2, and then automatically runs along a path Q7 while the elevating table and the article W are raised.

(2) The automated carrying cart A having reached a predetermined carry-in place lowers the elevating table by the elevating drive device to place the article W on the predetermined carry-in place.

(3) The unloaded automated carrying cart A automatically runs along a path Q8 in the shelf facility 2 and exits from the shelf facility 2, and automatically runs along a specific path P8 and enters into the shelf facility 2, and then automatically runs along a path Q9 while the elevating table and the article W are lowered.

(4) The automated carrying cart A having reached a predetermined carry-out place raises the elevating table by the elevating drive device to place the article W from the predetermined carry-out place onto the elevating table.

(5) The automated carrying cart A loaded with the article W automatically runs along a path Q10 in the shelf facility 2 and exits from the shelf facility 2, and then automatically runs along a specific path P9.

The storage facility using an automated carrying cart according to the embodiment of the present invention illustrated in the schematic plane view of FIG. 15 has a first-in first-out plane article storage space as an example.

### <Example of a Case of Carrying the Article Win and Out of the Shelf Facility 2>

(1) The automated carrying cart A loaded with the article W automatically runs along a specific path P10 and enters into the shelf facility 2, and then automatically runs along a path Q11 while the elevating table and the article W are raised.

(2) The automated carrying cart A having reached a predetermined carry-in place lowers the elevating table by the elevating drive device to place the article W on the predetermined carry-in place.

(3) The unloaded automated carrying cart A exits from the shelf facility 2, and automatically runs along a specific path P11 and enters into the shelf facility 2, and then raises the elevating table by the elevating drive device at a predetermined carry-out place to place the article W onto the elevating table.

(4) The automated carrying cart A loaded with the article W exits from the shelf facility 2 and automatically runs along a specific path P12.

The storage facility using an automated carrying cart according to the embodiment of the present invention illustrated in the schematic plane view of FIG. 16 has a random carry-in/out plane article storage space as an example.

The automated carrying cart A illustrated in FIG. 16 includes a telescopic fork device 28 as illustrated in FIG. 17, and the telescopic fork extends and contracts as shown by arrows N in FIG. 16.

### <Example of a Case of Carrying the Article Win and Out of the Shelf Facility 2>

(1) The automated carrying cart A loaded with the article W automatically runs along a specific path P13 and enters into the shelf facility 2, and then automatically runs along a path Q12 while the elevating table and the article W are raised.

(2) The automated carrying cart A having reached a position next to a predetermined carry-in place extends the telescopic fork device 28 illustrated in FIG. 17 to move the article W above the predetermined carry-in place, and lowers the elevating table by the elevating drive device to place the article W on the predetermined carry-in place, and then contracts the telescopic fork device 28.

(3) The unloaded automated carrying cart A automatically runs along a path Q13 and exits from the shelf facility 2, and automatically runs along a specific path P14 and enters into the shelf facility 2, and then automatically runs along a path Q14 while the elevating table is lowered.

(4) The automated carrying cart A having reached a position next to a predetermined carry-out place extends the telescopic fork device 28 illustrated in FIG. 17 and raises the elevating table by the elevating drive device to place the article W from the predetermined carry-out place onto the fork, and then contracts the telescopic fork device 28.

(5) The automated carrying cart A loaded with the article W automatically runs along a path Q15 in the shelf facility 2 and exits from the shelf facility 2, and then automatically runs along a specific path P15.

According to the thus configured storage facility using an automated carrying cart, the automated carrying cart automatically running along the running rails in the shelf facility and automatically running along a specific path on the ground are used in common for carrying an article in the shelf facility and carrying the article on the ground. This eliminates the need for a transfer device for unloading and reloading the article at the entry and exit of the shelf facility, thereby achieving the simplified structure of the storage facility.

In addition, the automated carrying cart automatically runs along a specific path on the ground, which eliminates the need for a carrying means such as a conveyor or an unmanned carrying cart, or a forklift operated by the worker to carry an article from a distant stock field to the shelf facility and carry the article from the shelf facility to a distant shipment field.

### REFERENCE SIGNS LIST

1 Storage facility
2 Shelf facility
3 and 4 Elevating device
5 Main frame
6 and 7 Sub frame
8 Elevating table
9 and 10 Cover
11A to 11D First running wheel
12A to 12D Second running wheel
13A Coupling
13B Shaft
13C Universal joint
13D Shaft
13E Sprocket
13F Chain
13G Sprocket
13H and 13I Idler sprocket
14A and 14B Bevel gear
14C Shaft
14D Sprocket
14E Chain
14F Sprocket
14G Idler sprocket
15A Sprocket
15B Chain
15C Sprocket
15D Shaft
15E Sprocket
15F Chain
15G Sprocket
15H and 151 Idler sprocket
16A Coupling
16B and 16C Bevel gear
16D Shaft
16E Sprocket
16F Chain
16G Sprocket
16H Idler sprocket
17A to 17D Switch cam
18A to 18D Roller
20A to 20D Cam follower
21A to 21D Hanger
22A and 22B Spur gear
22C Shaft
22D Sprocket
22E Chain
22F Sprocket
22G Idler sprocket
23A Universal joint
23B Shaft
23C Universal joint
23D Shaft
23E Sprocket
23F Chain
23G Sprocket
23H Idler sprocket
24A to 24D Elevating cam
25A to 25D Cam follower
26A and 26B Spur gear
26C Shaft
26D Universal joint
26E Shaft
26F Universal joint
26G Shaft
26H Sprocket
26I Chain
26J Sprocket
26K and 26L Idler sprocket
27A Sprocket
27B Chain
27C Sprocket
27D and 27E Idler sprocket
28 Telescopic fork device
A Automated carrying cart
B Back side
C Switch means
D1 Linear bush
D2 Pin
E1 Guide block
E2 Guide roller
F Front side
G, G1, and G2 Running rail
GR Guide roller
H1, H3, and H5 Raising path
H2, H4, and H6 Lowering path
I Battery
J Drive control device
K Elevating stroke
L Left side
M1 First running drive device
M2 Second running drive device
M3 Switch drive device
M4 Elevating drive device
N Extending and contracting direction
O1 and O2 Placement part
P1 to P15 Specific path
Q1 to Q15 Path
R Right side
S Article storage space
T1 and T2 Carrying direction
U1 and U2 Guide surface
W Article

1. A storage facility using an automated carrying cart that carries an article in and out of a shelf facility having an article storage space, wherein
the automated carrying cart automatically runs in the shelf facility along running rails and automatically runs on the ground outside the shelf facility along a specific path, and
the automated carrying cart is used in common for carrying the article in the shelf facility and carrying the article on the ground outside the shelf facility.

2. The storage facility using an automated carrying cart according to claim 1, wherein
the running rails are provided in the front-back direction and the left-right direction of the automated carrying cart, and
the automated carrying cart automatically runs in the shelf facility along the running rails in the front-back direction and the left-right direction.

3. The storage facility using an automated carrying cart according to claim 2, wherein
the automated carrying cart includes first running wheels and second running wheels with an axis of rotation orthogonal to that of the first running wheels, and
the automated carrying cart includes a switch means that switches between the state in which the first running wheels are grounded and the second running wheels are lifted and the state in which the second running wheels are grounded and the first running wheels are lifted.

4. The storage facility using an automated carrying cart according to claim 3, wherein driving torque of a running drive device is transferred to both the first running wheels and the second running wheels.

5. The storage facility using an automated carrying cart according to claim 4, wherein separate running drive devices drive the right and left first running wheels or the right and left second running wheels for use in running on the ground outside the shelf facility.

6. The storage facility using an automated carrying cart according to claim 1, wherein
the shelf facility has an article storage space with a plurality of vertical stories, and
the shelf facility includes an elevating device for passing the automated carrying cart between a position on the story at a desired height and a position on the ground.

7. The storage facility using an automated carrying cart according to claim 6, wherein the automated carrying cart automatically runs and enters into the elevating device, and automatically runs and exits from the elevating device.
